(19) United States
(12) Patent Application Publication
(10) Pub. No.: US 2015/0256402 A1
(43) Pub. Date: Sep. 10, 2015

(54) METHOD AND APPARATUS FOR GROUPING PERSONAL ELECTRONIC DEVICES USING INFORMATION PATTERN CODE

(71) Applicant: Samsung Electronics Co., Ltd., Gyeonggi-do (KR)

(72) Inventors: Woojun CHOI, Gyeonggi-do (KR); Juseung LEE, Gyeonggi-do (KR); Soonhyun CHA, Gyeonggi-do (KR); Sunmin HWANG, Gyeonggi-do (KR)

(21) Appl. No.: 14/640,172

(22) Filed: Mar. 6, 2015

(30) Foreign Application Priority Data
Mar. 6, 2014 (KR) 10-2014-0026341

(51) Int. Cl. H04L 12/24

(52) U.S. Cl. CPC H04L 41/0893; H04L 41/0806; H04L 41/0816

(57) ABSTRACT

The present disclosure relates to a method and an apparatus for grouping a plurality of personal electronic devices into one group and managing the plurality of personal electronic devices. According to various embodiments of the present disclosure, a method of registering personal electronic devices may include: obtaining an information code related to a second electronic device by a first electronic device; transmitting a registration request message including at least one among identification information on the first electronic device and information included in the obtained information code to a server by the first electronic device; and when the first electronic device has received a message including grouping information from the server, transmitting information related to the grouping information to the second electronic device and designating the first electronic device and the second electronic device as a group.

### CLAIM OF PRIORITY

This application claims priority from and the benefit under 35 U.S.C. §119(a) of Korean Patent Application No. 10-2014-0026341, filed on Mar. 6, 2014, which is hereby incorporated by reference for all purposes as if fully set forth herein.

### BACKGROUND

1. Technical Field

Certain embodiments presented herein relate to a method and an apparatus for grouping a plurality of personal electronic devices into one group and managing the plurality of personal electronic devices.

2. Description of the Related Art

Recently, as electronic technology has rapidly developed, people have a large number of electronic devices and the number of electronic devices tends to gradually increase. In addition, electronic devices which have recently been released generally apply wireless communication technologies with various schemes. The electronic devices which apply the wireless communication technologies may be various electronic devices, for example, a smart phone, a tablet computer, a notebook computer, or the like.

Therefore, when one user has and uses multiple electronic devices capable of wireless communication, generally the user uses wireless communication with an identical identifier, for example, an identical Twitter ID, an identical e-mail address, an identical phone number, or the like for each electronic device. When the user uses multiple electronic devices using one identifier, one message transmitted to the user ends up being transmitted to all of the corresponding user's electronic devices. Where electronic devices that are capable of communication have an identical identifier, according to the RCS5.X standard protocol, identical information is provided to all of the electronic devices that are capable of communication.

### SUMMARY

Various embodiments presented herein may alleviate a user using multiple electronic devices from the processing the same message by reading or reconfirming the same message several times. A user may have one electronic device which is used most often and other electronic devices are used for auxiliary means. For example, when the user uses a smart phone as a main electronic device, a tablet computer, a notebook computer, or the like which are voluminous and have a reduced mobility are generally used as auxiliary electronic devices. Accordingly, the user can identify a message, an e-mail, or the like in the main electronic device. However, in a system, an identical message comes to be transmitted to not only the smart phone but also the tablet or the notebook computer. Various embodiments presented herein allow the user to designate specific electronic devices to receive the message. Further, when one user has two or more electronic devices, the user should register a newly purchased electronic device.

According to various embodiments, when a user purchases a specific electronic device, the user may avoid the inconvenience, trials, and errors, or writing registration information to a serving using the Internet or the like. For example, the registration information may include tremendous amounts of information and information which is difficult to be easily understood by the user. For example, the registration information for the newly purchased electronic device, can include a user name, address and a user identifier (one or more of a phone number, an e-mail address, a Twitter address, or the like) as well as various pieces of information such as type information, a model name, an image, a serial number, applicable multimedia types, or the like of a purchased device. Various embodiments presented herein allow the main electronic device to register the newly purchased electronic device at the user's request.

Also, various embodiments may alleviate the inconvenience of an additional procedure when a user only desires that only a specific electronic device perform reception refusal and reception blocking. Various embodiments presented herein allow specification of the foregoing during the registration of electronic devices. Therefore, in various embodiments, there is included a method(s) by which a person can easily group and register electronic devices which the person purchases and a system(s) therefor may be provided.

Further, in various embodiments, there is a method(s) by which a person can divide electronic devices which the person purchases into two or more grades and manage the electronic devices. A system therefor may also be provided.

Further, in various embodiments, there is a method(s) by which a person can register other electronic devices through one main electronic device among multiple electronic devices which the person purchases and manage the electronic devices. A system therefor may also be provided.

A method of grouping personal electronic devices according to an embodiment may include: obtaining an information pattern code related to a second electronic device by a first electronic device; transmitting a registration request message including at least one among identification information on the first electronic device and information included in the obtained information pattern code to a server by the first electronic device; and when the first electronic device has received a message including grouping information from the server, transmitting information related to the grouping information to the second electronic device and designating the first electronic device and the second electronic device as a group.

In another embodiment, an electronic device for grouping personal electronic devices, the electronic device corresponding to a first electronic device for registering a second electronic device to a server, the electronic device comprises: a sensor module that recognizes an information pattern code related to the second electronic device; a memory that stores the from the information pattern code related to the second electronic device, grouping information and identifier information for the first electronic device; and a controller that controls to allow at least one among information included in an information code related to the second electronic device obtained in the sensor module and the identifier information on the first electronic device to be provided to the server, and when a message including the grouping information has been received from the server, controls to provide information related to the grouping information to the second electronic device; and a communication module that transmits the at least one among the information included in an information code related to the second electronic device obtained in the sensor module and the identifier information for the first electronic device is transmitted to the server, and that receives the message including the grouping information from the server.

In another embodiment, a non-transitory machine-readable medium storing a plurality of commands, wherein the plurality of commands, when being executed by at least one processor in a first electronic device, cause the at least one processor in the first electronic device to: receive information included in an information pattern code related to a second electronic device from a sensor module; provide a registration request message for transmitting including at least one among identification information for the first electronic device and information included in the obtained information pattern code to a server by the communication module; and provide information related to the grouping information for transmitting to the second electronic device by the communication module and designating the first electronic device and the second electronic device as a group, when the first electronic device has received a message including grouping information from the server.

When the certain embodiments are practiced, it is possible to easily group and register the electronic devices which the person purchases and to divide the electronic devices into two or more grades and manage the electronic devices. Accordingly, the user can more conveniently manage the electronic devices.

### BRIEF DESCRIPTION OF THE DRAWINGS

The above and other objects, features and advantages of the embodiments presented herein will be more apparent from the following detailed description in conjunction with the accompanying drawings, in which:

FIG. 1 illustrates an example of a system for grouping electronic devices into one main electronic device and sub electronic devices.

FIG. 2 is a block diagram illustrating a network environment including an electronic device which various embodiments may be applied to.

FIG. 3 is a block diagram illustrating a configuration where an electronic device for a control is a mobile communication terminal, according to various embodiments.

FIG. 4 is a signal flow diagram where sub electronic devices are registered using a main electronic device according to various embodiments.

FIG. 5 is a signal flow diagram for providing, where a message according to various embodiments is transmitted to a main electronic device and received by sub electronic devices.

### DETAILED DESCRIPTION

Hereinafter, embodiments of the present disclosure will be described with reference to the accompanying drawings. Although specific embodiments are illustrated in the drawings and related detailed descriptions are discussed in the present disclosure, the present disclosure may have various modifications and several embodiments. Accordingly, the present disclosure is not limited to a specific implementation form and it should be understood that the present disclosure includes all changes or equivalents and substitutes included in the spirit and scope of the present disclosure. In connection with descriptions of the drawings, similar components are designated by the same reference numeral.

The expressions such as “include” and “may include” which may be used in the present disclosure denote the presence of the disclosed functions, operations, and constituent elements and do not limit one or more additional functions, operations, and constituent elements. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Furthermore, in the present disclosure, the expression “and/or” includes any and all combinations of the associated listed words. For example, the expression “A and/or B” may include A, may include B, or may include both A and B.

Although the expressions such as “first” and “second” in the present disclosure can modify various constituent elements of the present disclosure, they do not limit the constituent elements. For example, the above expressions do not limit the sequence and/or importance of the corresponding elements. The above expressions may be used merely for the purpose of distinguishing one element from the other elements. For example, a first user device and a second user device indicate different user devices although both of them are user devices. For example, without departing from the scope of the present disclosure, a first structural element may be named a second structural element. Similarly, the second structural element also may be named the first structural element.

When an element is referred to as being “coupled” or “connected” to any other element, it should be understood that not only the element may be directly coupled or connected to the other element, but also a third element may be interposed therebetween. However, when a element is referred to as being “directly coupled” or “directly connected” to any other element, it should be understood that no element is interposed therebetween. In the present disclosure, the terms are used to describe a specific embodiment, and are not intended to be limiting. As used herein, the singular forms are intended to include the plural forms as well, unless the context clearly indicates otherwise.

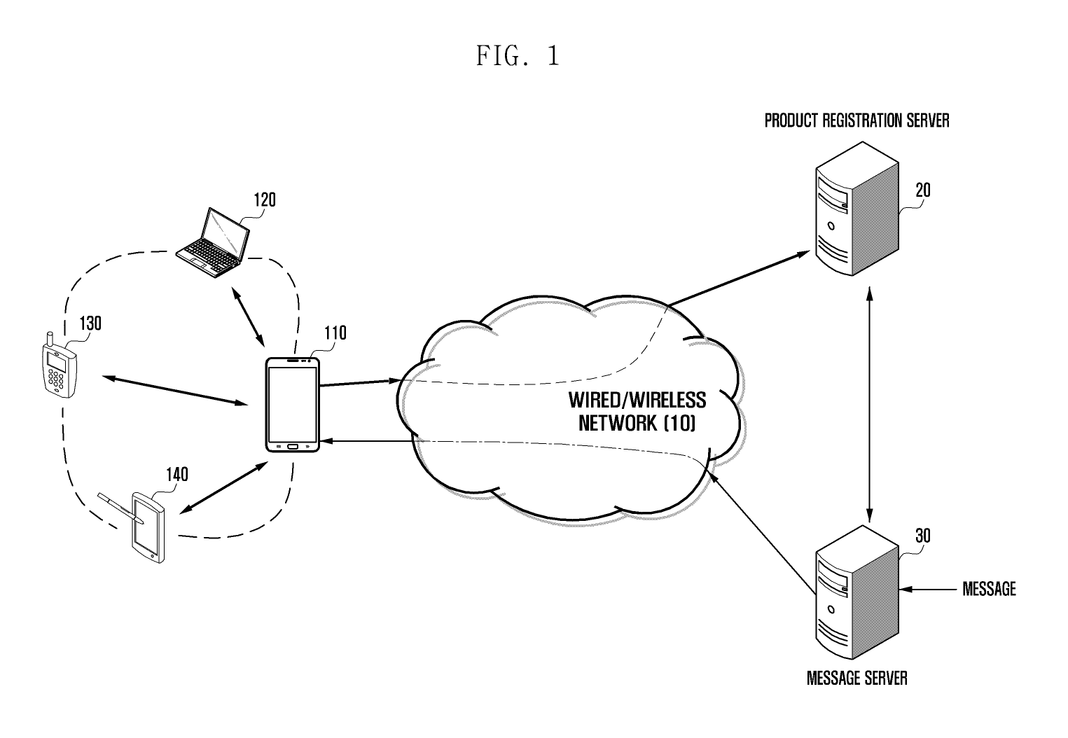

FIG. 1 illustrates an example of a system for grouping electronic devices into one main electronic device and sub electronic devices according to various embodiments.

Electronic devices 110, 120, 130 and 140 may be all electronic devices having communication functions and may be all be electronic devices capable of being registered as a main electronic device. However, in the system of FIG. 1, the first electronic device 110 is configured as a main electronic device and a second electronic device 120, a third electronic device 130 and a fourth electronic device 140 are configured as sub electronic devices. For example, the first electronic device 110 may be a smart phone, the second electronic device 120 may be a notebook computer, the third electronic device 130 may be an RCS mobile terminal, and the fourth electronic device 140 may be a tablet computer.

The main electronic device 110 may perform communication with a product registration server 20 through a wired and/or wireless network 10. As a result, the main electronic device 110 may perform a product registration procedure for the sub electronic devices 120, 130, and 140. In certain embodiments, the main electronic device 110 may be an electronic device including a camera function. The main electronic device 110 may photograph an information pattern code, for example, a Quick Response (QR) code, which is printed or carved on a case or a packing of a newly purchased electronic device using a camera function. As another method of providing the information pattern code, the information pattern code may be displayed in a display module of a newly purchased electronic device using a program installed in the newly purchased product.

Further, the main electronic device 110 may obtain information on an electronic device from an information pattern code such as a QR code using a camera or other sensors and store the information, thereby transmitting the information to the product registration server 20 through the wired and/or wireless network 10 to perform the registration procedure.

In this event, a new electronic device which newly performs the registration procedure may be registered as the sub electronic device of the main electronic device 110 and a user can configure reception or blocking with respect to specific information according to the user's needs. When the new electronic device is classified into the main electronic device 110 and the sub electronic devices 120, 130 and 140, all electronic devices do not exist as electronic devices having an identical level, but the sub electronic devices 120, 130 and 140 may hierarchically exist through the main electronic device 110. In an embodiment, the main electronic device 110 is registered as a representative electronic device, and the sub electronic devices 120, 130 and 140 may exist as electronic devices of a lower layer of the main electronic device 110. Therefore, other electronic devices 120, 130 and 140 may be formed to be one group and the main electronic device 110 is registered as a representative electronic device.

When the network information, e.g., an IP address, changes as each sub electronic device moves, the sub electronic devices 120, 130 and 140 may provide changed network information to the main electronic device 110.

The product registration server 20 may be a manufacturer server of the product, a server of a communication company, or other various servers for registering other products. For example, when the main electronic device 110 configures an e-mail address as a representative identifier, the product registration server 20 may be an e-mail server or a registration server of a company providing an e-mail service. In addition, when the main electronic device 110 configures and uses a phone number of a mobile communication system as a representative identifier, the product registration server 20 may be a product registration server of a mobile communication company. When the main electronic device 110 uses other applications such as Twitter, messenger, and the like as a representative identifier, a corresponding server may be the product registration server 20.

The product registration server 20 may distinguish the main electronic device 110 from sub electronic devices and store them, and may store information such as a message to be received, an address to be blocked, or the like from the main electronic device 110. Further, the product registration server 20 may store information setting forth which types of messages that are only to be transmitted to the main electronic device 110 and specific sub electronic devices, e.g., 120, 130, 140. For example, the product registration server may store information directing that a Short Message Service (SMS) or Multi-Media Messaging Service (MMS) message is only transmitted to the main electronic device and information from Twitter or a messenger is supposed to be transmitted to the sub electronic devices 120, 130 and 140. In the case of an e-mail, information configured to be only transmitted to the main electronic device 110 and the second electronic device 120 may be stored.

Where a data transmission is to be requested with an identifier of a specific electronic device, a message server 30 may inquire about location information for a corresponding electronic device, information for the sub electronic devices connected to a lower layer of the corresponding main electronic device, information on which types of messages are supposed to be transmitted to which sub electronic devices, or the like to the product registration server 20. The product registration server 20 provides the requested information to the message server 30. In an embodiment, when the message server 30 is a server providing a video-call service, it is possible to inquire about which electronic device the video-call service is to be provided to among corresponding electronic devices to the product registration server 20. If necessary, the location information may be obtained from the product registration server 20.

In an embodiment, where the message server 30 is a server for providing video-call service, the message server 30 may make an inquiry to the product registration server 20 in order to provide the video-call service. Accordingly, when a call connection between the first electronic device 110 which is the main electronic device and the fourth electronic device 140 is permitted according to the information requested by the message server 30 to the registration server 20, an incoming call signal for providing the video-call service may be provided to the fourth electronic device 140.

In another embodiment, where the message server 30 is the server for providing SMS or MMS service, the message server 30 may inquire, whether to provide SMS or MMS service to the electronic devices, to the product registration server 20. As a result of the inquiry, when the SMS or MMS service should be only provided from the product registration server 20 to the first electronic device 110 which is the main electronic device, the message server 30 may only provide SMS or MMS data to the first electronic device 110.

The main electronic device and the sub electronic devices as briefly described above may be devices with communication functions. For example, the electronic device may be, but is not limited to a combination of one or more of a smartphone, a tablet personal computer, a mobile phone, a video phone, an e-book reader, a desktop personal computer, a laptop personal computer, a netbook computer, a Personal Digital Assistant (PDA), a Portable Multimedia Player (PMP), an MP3 player, a mobile medical device, an electronic bracelet, an electronic necklace, an electronic accessory, a camera, a wearable device, an electronic clock, a wrist watch, a home appliance (e.g. a refrigerator, an air conditioner, a cleaner, an oven, a microwave oven, a washing machine, a vacuum cleaner, etc.), an artificial intelligent robot, a Television (TV), a Digital Video Disk (DVD) player, an audio player, various medical machines (e.g. a Magnetic Resonance Angiography (MRA), a Magnetic Resonance Imaging (MRI), a Computed Tomography (CT), a tomography camera, a sonography device, etc.), a navigation device, a Global Positioning System (GPS) receiver, an Event Data Recorder (EDR), a Flight Data Recorder (FDR), a set-top box, a TV box (e.g. SamSung HomeSync™, Apple TV™, or Google TV™), an electronic dictionary, a vehicle infotainment device, electronic equipment for a ship (e.g. navigation equipment for a ship, a gyrocompass, etc.), avionic equipment, a security device, an electronic cloth, an electronic key, a camcorder, a game console, a Head-Mounted Display (HMD), a flat panel display device, an electronic frame, an electronic album, a furniture or a part of a building/structure including a communication function, an electronic board, an electronic signature receiving device, a projector, etc.

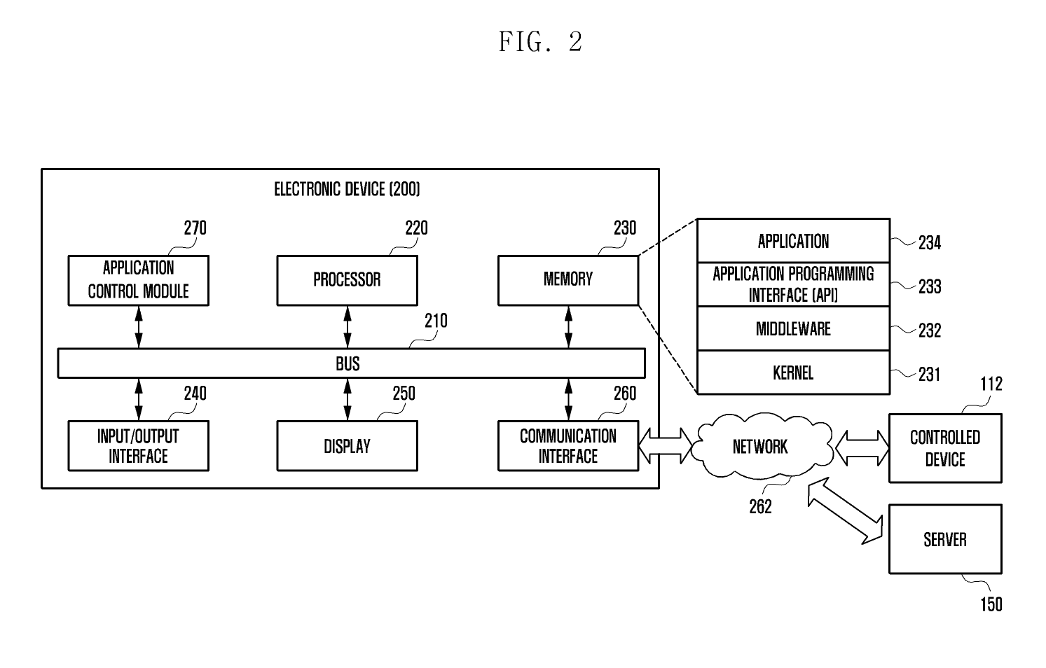

FIG. 2 is a block diagram illustrating a network environment including an electronic device which the various embodiments may be applied to.

An electronic device 200 illustrated in FIG. 2 may be the main electronic device 110 as described above or sub electronic devices 120, 130 and 140. The electronic device 200 may include a bus 210, a processor 220, a memory 230, an input/output interface 240, a display 250, a communication interface 260 and an application control module 270. The electronic device 200 may further include other components other than components as described above.

The bus 210 may be a circuit connecting the above described component elements and transmitting communication (e.g. a control message) between the above described components.

The processor 220 may, for example, receive a command from other component elements (e.g., the memory 230, the input/output interface 240, the display 250, the communication interface 260, the application control module 270, etc.), through the bus 210, may decrypt the received command, and may execute an operation or process data based on the decrypted command.

The memory 230 may store a command or data received from the processor 220 or other component elements (e.g., the input/output interface 240, the display 250, the communication interface 260, the application control module 270, etc.), or generated by the processor 220 or other component elements. The memory 230 may include programming modules, for example, a kernel 231, a middleware 232, an Application Programming Interface (API) 233, an application 234, and the like. Each of the programming modules described above may include software, firmware, and hardware, or a combination thereof. Further, when the memory 230 is loaded in the main electronic device 110, according to an embodiment, the memory 230 may include an area for storing information on the sub electronic devices 120, 130 and 140, an area for storing control data for performing a procedure for registering the sub electronic devices 120, 130 and 140 in the product registration server 20 and an area for storing control data for sharing data with the sub electronic devices 120, 130 and 140. Further, when the memory 230 is loaded in the sub electronic device, the memory 230 may include an area for communicating with the main electronic device 110 and storing control data for operating as the sub electronic device.

The kernel 231 may control or manage system resources, for example, the bus 210, the processor 220, the memory 230, and the like, used for executing an operation or function implemented in other programming modules, for example, the middleware 233, the API 233, or the application 234. Further, the kernel 231 may provide an interface which can access individual component elements of the electronic device 200 in the middleware 232, the API 233 and the application 234 to control or manage the individual component elements.

The middleware 232 may perform an intermediating role so as to allow the API 233 or the application 234 to communicate with the kernel 231 and exchange data. Further, with respect to work requests received from the application 234, the middleware 232 may perform a control (e.g., a scheduling or a load balancing) for the work requests using, for example, a method of assigning priorities for use of system resources (e.g., the bus 210, the processor 220, the memory 230, or the like) of the electronic device 200.

The API 233 is an interface used by the application 234 to control a function provided from the kernel 231 or the middleware 232, and may include, for example, at least one interface or function (for example, an instruction), for a file control, a window control, image processing, a character control, or the like.

The application 234 may include an SMS/MMS application, an e-mail application, a calendar application, an alarm application, a health care application (for example, an application for measuring an amount of exercise or blood sugar), an environmental information application (for example, an application for providing an atmospheric pressure, humidity information, temperature information, and the like), and the like. Further, the application 234 may be an application related to information exchange between the electronic device 200 and an external electronic device (for example, controlled devices 112 and 122 or other electronic devices). The application 234 may be respectively configured by an application for controlling the controlled devices and an application for communicating with the server 150 or may be configured by an application for controlling the controlled devices and an application for communicating with a combined type. The application associated with exchanging information may include, for example, a notification relay application for transferring predetermined information to an external electronic device or a device management application for managing an external electronic device.

For example, a notification relay application may include a function for relaying notification information generated in another application (e.g., a SMS/MMS application, an e-mail application, a health care application, an environment information application, or the like) of the electronic device 200 to the external electronic device (e.g., controlled devices 112 and 122 or other electronic devices). Further, the notification relay application may receive the notification information from, for example, the external electronic device (e.g., controlled devices 112 and 122 or other electronic devices) and provide the notification information to the user. The device management application may manage (e.g., install, delete or update) at least a part of a function (e.g., turning the external electronic device (or some elements thereof) on or off, or adjusting the brightness (or resolution) of a display) of the external electronic device (e.g., controlled devices 112 and 122 or other electronic devices) which communicates with the electronic device 200, an application operated in the external electronic device, or a service (e.g., a call service or a message service) provided in the external electronic device.

In addition, the application 234 may include an application designated according to an attribute (e.g., the kind of electronic device) of the external electronic device (e.g., controlled devices 112 and 122 or other electronic devices). For example, when the external electronic device is a MP3 player, the application 234 may include an application related to the reproduction of music. Similarly, when the external electronic device is a mobile medical device, the application 234 may include an application related to health care. Further, when the external electronic device is a household temperature control system, the application 234 may include an application related to a household temperature control.

The application 234 may include at least one application between an application designated in the electronic device 200 or an application received from the external electronic device (e.g., the server 150, the controlled devices 112 and 122 or other electronic devices).

The input/output interface 240 may relay a command or data which is input from the user through the input/output device (e.g., a sensor, a keyboard or a touch screen) to the processor 220, the memory 230, the communication interface 260 or the application control module 270 through, for example, the bus 210. For example, the input/output interface 240 may provide, to the processor 220, data associated with a touch of a user input through a touch screen. Further, the input/output interface 240 may output a command or data, which is received from the processor 220, the memory 230, the communication interface 260 or the application control module 270 through the bus 210, through the input/output device (e.g., a speaker or a display). For example, the input/output interface 240 may output voice data processed by the processor 220 to the user through a speaker.

The display 250 may display various pieces of information (e.g., multimedia data, text data, etc.) to the user.

The communication interface 260 may connect a network 262 between the electronic device 200 and an external electronic device (for example, the controlled devices 120, 130, and 140, other electronic devices, or servers 20, 30). For example, the communication interface 260 may be connected to a network 262 through wireless communication or wired communication, and may communicate with an external device. The wireless communication may include, but is not limited to, at least one of, a Wireless Fidelity (Wifi), Bluetooth (BT), Near Field Communication (NFC), Global Positioning System (GPS) and cellular communication (for example, Long Term Evolution (LTE), LTE-A, Code Division Multiple Access (CDMA), Wideband CDMA (WCDMA), Universal Mobile Telecommunication System (UMTS), Wireless Broadband (WiBro), or Global System for Mobile communication (GSM) or the like. The wired communication may include, but is not limited to, at least one of, for example, a Universal Serial Bus (USB), a High Definition Multimedia Interface (HDMI), a Recommended Standard 232 (RS-232), and a Plain Old Telephone Service (POTS).

The network 262 may be a telecommunication network. The telecommunication network may include at least one of a computer network, the Internet, the Internet of things and a telephone network. Further, a protocol (e.g., a transport layer protocol, a data link layer protocol or physical layer protocol) for communication between the electronic device 200 and the external electronic device may be supported by at least one among the application 234, the application programming interface 233, the middle ware 232, the kernel 231 and the communication interface 260.

The application control module 270 may process at least some information obtained from other component elements (e.g., the processor 220, the memory 230, the input/output interface 240, the communication interface 260, or the like) and may provide the other components to the user using various methods. For example, the application control module 270 may recognize information on a connection component which is equipped in the electronic device 200, store the information on the connection component in the memory 230 and execute the application 234 based on the information on the connection component.

In above description, the processor 220 and the application control module 270 has been described as being separate. However, the application control module 270 may be loaded in the processor 220, and the processor 220 and the application control module 270 may be referred as to a “controller”.

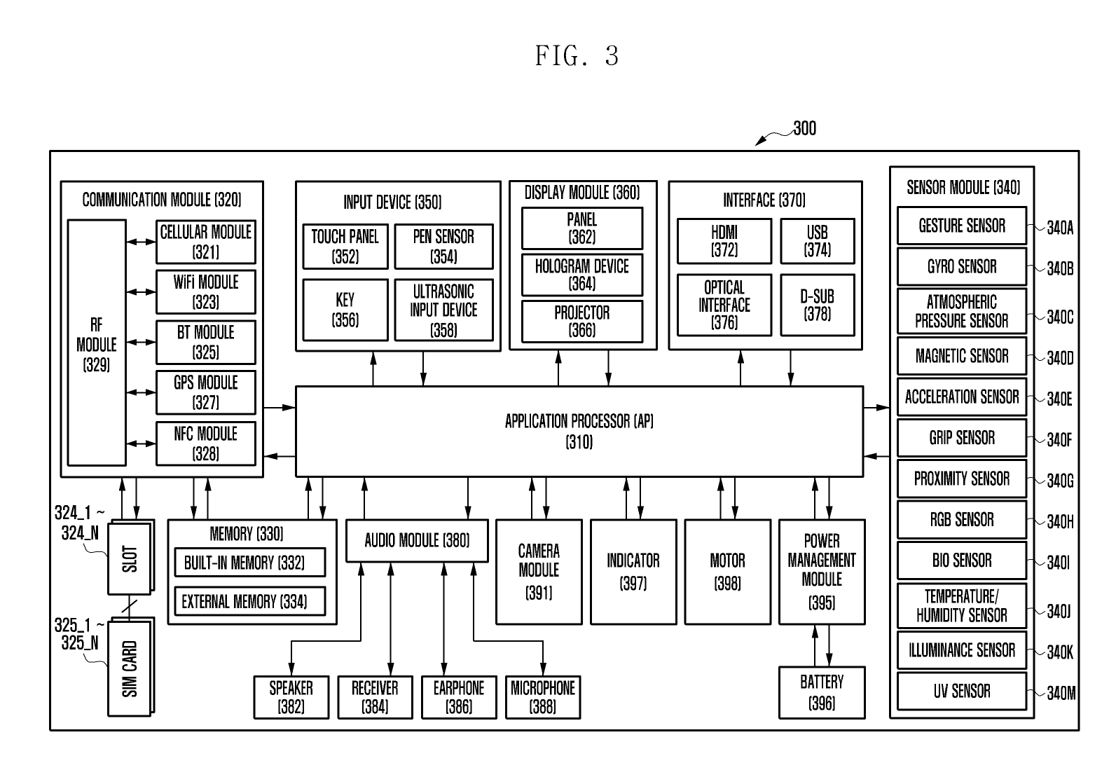

FIG. 3 is a block diagram illustrating a configuration when an electronic device for a control is a mobile communication terminal.

Referring to FIG. 3, an electronic device 300 may include the whole or a part of the electronic device 200 shown in FIG. 2. Further, the electronic device 300 may have the whole or a part of the configuration shown in FIG. 3, another configuration not shown therein, or a part of the configuration shown therein together with the another configuration not shown therein.

The electronic device 300 may include one or more application processors (AP) 310, communication modules 320, subscriber identification module (SIM) cards 325, memories 330, sensor modules 340, input devices 350, displays 360, interfaces 370, audio modules 380, camera modules 391, power management modules 395, batteries 396, indicators 397 and motors 398.

The AP 310 may operate an operation system or an application program to control a plurality of hardware or software component elements connected to the AP 310 and perform processing and operations using various data including multimedia data. The AP 310 may be configured by, for example, a system on chip (SoC). In addition, the AP 310 may further include a graphic processing unit (GPU) (not shown).

The communication module 320 (e.g., the communication interface 160) may perform data transmission and reception in communication between the electronic device 200 (e.g., the electronic device 101) and other electronic devices connected through a network (e.g., the controlled devices 112 and 122, other electronic devices or the server 150). Further, the communication module 320 may include the cellular module 321, a Wifi module 323, a BT module 325, a GPS module 327, a NFC module 328 and a radio frequency (RF) module 329.

The cellular module 321 may provide a voice call, a video call, an SMS, or an Internet service through a communication network (for example, LTE, LTE-A, CDMA, WCDMA, UMTS, WiBro, or GSM. Furthermore, the cellular module 321 may distinguish and authenticate electronic devices within a communication network using a subscriber identification module (e.g., the SIM card 325). The cellular module 321 may perform at least some of the functions which can be provided by the AP 310. For example, the cellular module 321 may perform at least a part of a multimedia control function.

Further, the cellular module 321 may include a communication processor (CP). Furthermore, the cellular module 321 may be implemented by, for example, an SoC. In FIG. 3, component elements of the cellular module 321 (e.g., communication processor), the memory 330, the power management module 395, or the like are illustrated as component elements which are separated from the AP 310, but may be implemented to allow the AP 310 to include at least a part (e.g., the cellular module 321) of the component elements as described above.

Further, the AP 310 or the cellular module 321 (e.g., a communication processor) may load a command or data which is received from at least one among a non-volatile memory or other component elements respectively connected to the AP 310 and the cellular module 321 into a volatile memory to process the command or the data. Further, the AP 310 or the cellular module 321 may store data received from or generated by at least one of the other component elements in a non-volatile memory.

Each of the WiFi module 323, the BT module 325, the GPS module 327 or the NFC module 328 may include a processor for processing data transmitted and received through a corresponding module. In FIG. 3, the cellular module 321, the WiFi module 323, the BT module 325, the GPS module 327 or the NFC module 328 are illustrated by each separate block, but at least a part (e.g., two or more) of the cellular module 321, the WiFi module 323, the BT module 325, the GPS module 327 or the NFC module 328 may be included within one integrated chip (IC) or IC package. For example, at least a few (for example, a CP corresponding to the cellular module 321 and a Wi-Fi processor corresponding to the Wi-Fi module 323) of processors corresponding to the cellular module 321, the Wi-Fi module 323, the BT module 325, the GPS module 327, and the NFC module 328, respectively, may be embodied as a single SoC.

The RF module 329 may transmit and receive a RF signal for transmitting and receiving data. The RF module 329 may include, for example, a transceiver, a Power Amp Module (PAM), a frequency filter, a Low Noise Amplifier (LNA), or the like, although not illustrated. Further, the RF module 329 may further include a component, for example, a conductor, a conducting wire, or the like for transmitting and receiving an electromagnetic wave over a free air space in the wireless communication. Although the cellular module 321, the Wi-Fi module 323, the BT module 325, the GPS module 327, and the NFC module 328 are illustrated to share a single RF module 329, at least one of the cellular module 321, the Wi-Fi module 323, the BT module 325, the GPS module 327, and the NFC module 328 may transmit/receive the RF signal through separate RF modules.

SIM cards 325_1˜N may be cards including a subscriber identification module and may be inserted to slots 324_1˜N formed at a specific location of the electronic device. The SIM card 325_1˜N may include unique identification information such as Integrated Circuit Card Identifier (ICCID), or subscriber information such as International Mobile Subscriber Identity (IMSI).

The memory 330 may include an internal memory 332 or an external memory 334. The internal memory 332 may include at least one of a volatile memory (e.g., a Dynamic Random Access Memory (DRAM), a Static RAM (SRAM), a Synchronous Dynamic RAM (SDRAM), or the like) or a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, or the like). Further, the internal memory 332 may be a Solid State Drive (SSD). The external memory 334 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 334 may be functionally connected to the electronic device 200 through various interfaces. In addition, the electronic device 200 may further include a storage device (or, a storage media) such as a hard-drive.

The sensor module 340 may measure a physical quantity or detect an operation state of the electronic device 200 to convert the measured or detected information into an electronic signal. The sensor module 340 may include, for example, at least one of a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (for example, red, green, and blue (RGB) sensor), a biometric sensor 340I, a temperature/humidity sensor 340J, an illumination sensor 340K, and an Ultra Violet (UV) sensor 340M. Further, the sensor module 340 may include, for example, an E-nose sensor (not shown), an electromyography (EMG) sensor (not shown), an electroencephalogram (EEG) sensor (not shown), an electrocardiogram (ECG) sensor (not shown), an infra red (IR) sensor (not shown), an iris sensor (not shown), a fingerprint sensor (not shown), or the like. The sensor module 340 may further include a control circuit for controlling one or more sensors included therein.

The input device 350 may include a touch panel 352, a (digital) pen sensor 354, a key 356, or an ultrasonic input device 358. The touch panel 352 may recognize a touch input based on, for example, at least one of a capacitive scheme, a resistive scheme, an infrared scheme, and an acoustic wave scheme. In addition, the touch panel 352 may further include a control circuit. The capacitive scheme touch panel may recognize physical contact or proximity. The touch panel 352 may further include a tactile layer. In this case, the touch panel 352 may provide a user with a tactile reaction.

The (digital) pen sensor 354 may be implemented, for example, using a method identical or similar to a method of receiving a touch input of a user, or using a separate sheet for recognition. The key 356 may include a physical button, an optical key or a keypad. The ultrasonic input device 358 is a device, which can detect sonic waves with a microphone (e.g., a microphone 388) in the electronic device 200 and identify data through an input tool generating an ultrasonic signal, and can perform a wireless recognition. Further, the electronic device 200 may receive a user input from the external device (e.g., computer or server) connected to the electronic device 200 using the communication module 320.

The display 360 (e.g., display 250) may include a panel 362, a hologram device 364 or a projector 366. For example, the panel 362 may be, for example, a Liquid Crystal Display (LCD), an Active Matrix Organic Light Emitting Diode (AM-OLED), or the like. Further, the panel 362 may be implemented to be flexible, transparent or wearable. In addition, the panel 362 may be configured by the touch panel 352 and one module. The hologram 364 may show a three dimensional image in the air using the interference of light. The projector 366 may project light on a screen and display an image. The screen may be located, for example, on the inside or outside of the electronic device 200. Therefore, the display 360 (e.g., display 250) may further include a control circuit for controlling the panel 362, the hologram device 364 or the projector 366.

The interface 370 may include, for example, an HDMI 372, USB 374, an optical interface 376, or a D-subminiature (D-sub) 378. The interface 370 may be included in the communication interface 260 shown in FIG. 2. Further, the interface 370 may include a mobile high-definition link (MHL) interface, a secure digital (SD) card/multi-media card (MMC) interface or an infrared data association (IrDA) standard interface.

The audio module 380 may convert a sound and an electrical signal in bi-directions. At least a part of component elements of the audio module 380 may be included in the input/output interface 240 shown in FIG. 2 as described above. Further, the audio module 380 may process sound information which is input and output through a speaker 382, a receiver 384, an earphone 386, a microphone 388, or the like.

The camera module 391 is a device which can photograph a still image and a video, and may include one or more of an image sensor (e.g., a front sensor or a rear sensor) (not shown), a lens (not shown), an image signal processor (ISP) (not shown) or a flash (not shown) (e.g., a LED or a xenon lamp).

The power management module 395 may manage a power of the electronic device 200. Although not illustrated, the power management module 395 may include, for example, a Power Management Integrated Circuit (PMIC), a charger Integrated Circuit (IC), or a battery or fuel gauge.

The PMIC may be loaded within a SoC semiconductor. Charging methods may be classified into a wired charging method and a wireless charging method. The charger IC can charge a battery and can prevent introduction of over-voltage or over-current from a charger. The charger IC may include a charger IC for at least one scheme of a wired charging scheme or a wireless charging scheme. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added.

The battery gage may measure a residual quantity of the battery 396 and a voltage, a current or a temperature during charging. The battery 396 may store or generate electricity and may supply a power to the electronic device 200 using the stored or generated electricity. The battery 396 may include a rechargeable battery or a solar battery.

The indicator 397 may display a specific state, for example, a booting state, a message state, a charging state or the like of the electronic device 200 or a part thereof (e.g., the application processor 310). The motor 398 may convert an electrical signal into a mechanical vibration. Although not illustrated, the electronic device 200 may include a processing unit (e.g., a Graphics Processing Unit (GPU)) for supporting a mobile TV. The processing unit for supporting the mobile TV can process media data according to a standard of Digital Multimedia Broadcasting (DMB), Digital Video Broadcasting (DVB), media flow, or the like.

An electronic device according to various embodiments, the electronic device corresponding to a first electronic device for registering a second electronic device to a server, the electronic device includes: a sensor module that recognizes an information pattern code related to the second electronic device; a communication module that provides information for the second electronic device and identification information for the first electronic device to a server; a memory that stores the information for the second electronic device, grouping information and identifier information for the first electronic device; and a controller that controls to allow at least one among information included in the information pattern code related to the second electronic device obtained in the sensor module and the identifier information for the first electronic device to be transmitted to the server through the communication module, and when a message including the grouping information has been received from the server through the communication module, controls to provide information related to the grouping information to the second electronic device.

Each of the components of the electronic device according to the present embodiments may be implemented by one or more components and the name of the corresponding component may vary depending on the type of the electronic device. The electronic device according to the embodiments presented herein may include one or more of the aforementioned components or may further include other additional components, or some of the aforementioned components may be omitted. Further, some of the components of the electronic device according to embodiments presented herein may be combined to be one entity, which can perform the same function as each of the combine combined components.

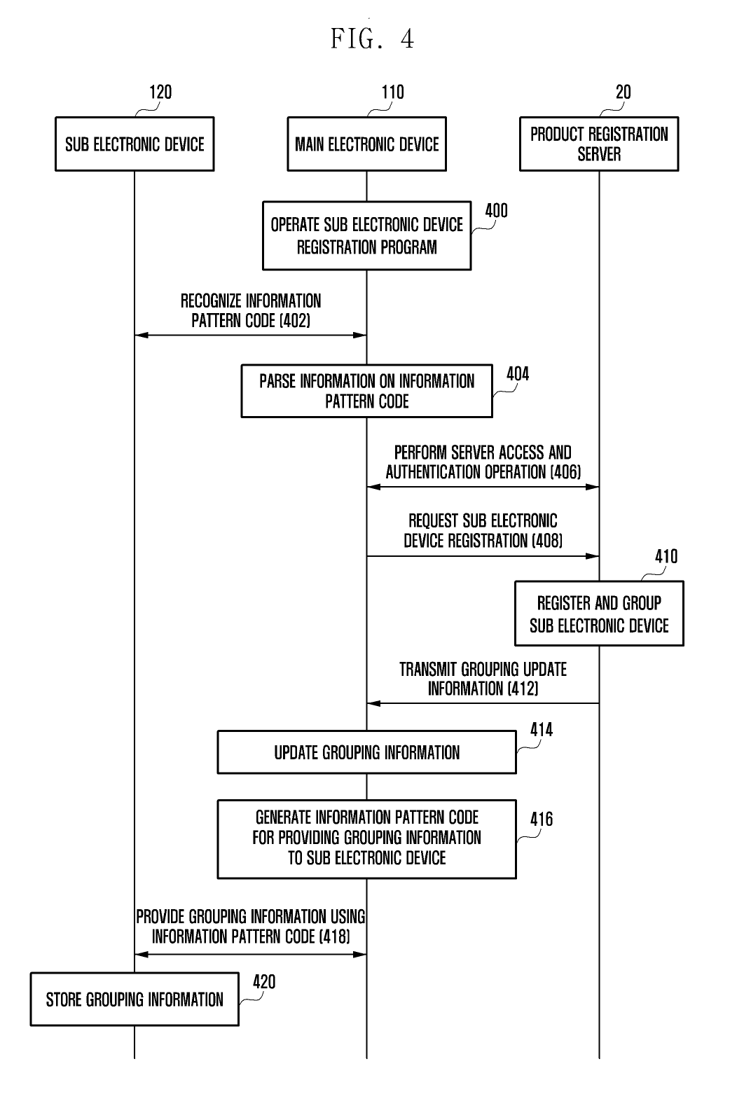

FIG. 4 is a signal flow diagram where sub electronic devices are registered using a main electronic device according to various embodiments.

Referring to FIG. 4, a sub electronic device shall be the second electronic device 120 in FIG. 1 as an example, and is considered an electronic device which is not grouped after being newly purchased. Further, the first electronic device 110 in FIG. 1 shall be considered the main electronic device. A configuration of the main electronic device 110 and the sub electronic device 120 will be discussed in reference to configurations of FIGS. 2 and 3. It should be understood that although in the present case, the main electronic device is the first electronic device 110 and the sub electronic device is the second electronic device 120, any one of the first electronic device 110, the second electronic device 120, the third electronic device 130, and the fourth electronic device 140, can be a main electronic device or a sub electronic device.

In certain embodiments, the main electronic device 110 operates the camera module 391 included in the main electronic device 110 when operating a predetermined program for registering the sub electronic device in operation 400. A reason for operating the camera module 391 included in the main electronic device 110 is to obtain an information pattern code which is printed on the packing or a case of the sub electronic device 120 using the camera module 391. As described above, the information pattern code may be stored in the sub electronic device 120 and may be displayed in the display module through a predetermined program, or the like. In the following description, a method of obtaining the information pattern code through the camera module 391 will be described as an embodiment. However, other embodiments may obtain the information pattern code using various sensors other than the method of obtaining the information pattern code using the camera module 391.

The information pattern code can be a QR code, a bar code, or another information pattern code which may be developed. However, information for the registration of the sub electronic device 120 is included in the information pattern code. Further, when the main electronic device 110 uses the bar code or other codes than the QR code, if necessary, the main electronic device 110 may further include a sensor or an information acquisition module for obtaining the information pattern code. In following description, for a convenience of the description, the case of using the QR code will be described as an example, although it should be understood that other information pattern codes can be used.

In operation 402, the main electronic device 110 may recognize information included in the information pattern code through an operation of recognizing an information pattern code such as operations of photographing or focusing on the information pattern code using the camera module 391. The information pattern code may include, for example, device type information, model name information, image information and a serial number of the sub electronic device 120, a multimedia format information which the sub electronic device can support, or the like.

The main electronic device 110 obtaining the information parses information on the information pattern code in order to group the sub electronic device 120 into an electronic device of a lower layer of the main electronic device 110 using at least one piece of information among information obtained from the information pattern code and register the sub electronic device on the product registration server 20 in operation 404.

The main electronic device 110 may perform a server access operation and an authentication operation with the product registration server 20 in operation 406. The server access operation and the authentication operation may be an operation in which the electronic device generally accesses a predetermined server through a predetermined network, e.g., a mobile network or a wired network, and is authenticated by its own ID. For example, when accessing the product registration server 20 through the mobile network, the main electronic device 110 may access to the product registration server by providing information such as a phone number, an e-mail address, or the like of the main electronic device and a password. If necessary, when passing a dual-authentication in order to register a sub electronic device 120 to the product registration server 20, the main electronic device 110 may obtain a separate password for the dual-authentication from the user and further provide the separate password to the product registration server 20. Afterward, the main electronic device 110 may transmit a registration request signal for registering the information for the sub electronic device obtained from the information pattern code which can be displayed in the display module from a packing, a case, a program embedded in the product, or the like of the sub electronic device 120 to be newly registered to the lower layer of the electronic device of the main electronic device 110 in operation 408.

In various embodiments, the main electronic device 110 may be a smart phone. A case in which the main electronic device 110 is the smart phone will be described in more detail as an example. The main electronic device 110 may obtain the information on the information pattern code in operation 404 and request automatic or manual access to the product registration server 20 using its own phone number or its own phone number and a serial number of the product in operation 406. The product registration server 20 may authenticate the main electronic device 110 using the phone number or the phone number and the serial number of the product.

The product registration server 20 may provide information for registering the sub electronic device to the main electronic device 110 or the main electronic device 110 may provide the information on the sub electronic device 120 obtained from the information pattern code to the product registration server 20 in operation 408. If the product registration server 20 provides information for registering the sub electronic device to the main electronic device 110, the main electronic device 110 may display, on the display module 360, contents inquiring whether to register the obtained sub electronic device 120. When the user requests registration through the input device 350 of the main electronic device 110, the main electronic device 110 may provide the information obtained from the information pattern code to the product registration server 20 in operation 408.

Further, when the sub electronic device 120 is registered as in operation 408, information regarding the type of data which can be received by the sub electronic device, for example, the kind of messages which can be simultaneously received by the main electronic device 110 and sub electronic device 120 and the kind of messages which can be only received by the main electronic device 110 can be configured together. For example, in a case of the SMS or MMS message, the main electronic device 110 only receives the SMS or MMS, and the sub electronic device 120 which is the second electronic device may configure a video call and an e-mail service to be only received together with the main electronic device 110 and may configure an e-mail service to be only received together with the main electronic device 110. In the above description, although SMS, MMS, a video call, an e-mail service, or the like has been only described as an example. Other examples include, but are not limited to, a push message, update information on an application program, or the like which are provided from other specific application program or a server may be configured together.

As described above, when the main electronic device 110 provides both the information for the sub electronic device 120 and the information for the main electronic device 110 to the product registration server 20, the product registration server 20 may register the sub electronic device 120 as an electronic device of the lower layer of the main electronic device 110 to an internal database (DB). One or more sub electronic devices may be included in the lower layer of the main electronic device 110 and the main electronic device 110 and the electronic devices of the lower layer thereof may be formed by one group.

When a grouping has been completed in operation 410, the product registration server 20 may generate information on the sub electronic devices which exists in the lower layer of the main electronic device 110 as grouping update information so as to transmit the grouping update information to the main electronic device 110 in operation 412. In this event, the grouping update information which the product registration server 20 provides to the main electronic device 110 may include information for the newly registered second electronic device 120 and information on the other previously registered sub electronic devices. For example, when the third electronic device 130 and the fourth electronic device 140 have already been registered as sub electronic devices of the first electronic device 110 which is the main electronic device, the grouping update information may include the information on the second electronic device, information on the third electronic device 130 and information on the fourth electronic device 140. As another example, the grouping update information may only include information on a newly added second electronic device 120.

When receiving the grouping update information in operation 412, the main electronic device 110 may perform an operation for updating the grouping information in operation 414. For example, the information on the newly added second electronic device 120 may be stored in the memory 330 as a state of being registered to the server 20.

The main electronic device 110 may generate an information pattern code for providing grouping information to the sub electronic device 120 in operation 416. The information pattern code can be a QR code, a bar code or any code to be developed afterward. However, the information pattern code includes the information on the main electronic device 110 and information informing the sub electronic device 120 that the sub electronic device 120 is included as one of the electronic devices of the lower layer of the main electronic device 110. If necessary, the information pattern code may further provide information on other sub electronic devices.

The main electronic device 110 may generate an information pattern code for providing grouping information to the sub electronic device 120 and display information on the display module 360. Information displayed on the display module 360 of the main electronic device 110 can be obtained by the sub electronic device 120 using the camera module 391 included in the sub electronic device in operation 418. Then, the sub electronic device 120 may store the grouping information in a corresponding area of the memory in operation 420.

In operations 416 to 420, a case in which the main electronic device 110 provides the grouping information to the sub electronic device 120 using the information pattern code has been described. It should be understood that grouping information can be provided in other ways. However, when an identical wired or wireless communication scheme is used between the main electronic device 110 and the sub electronic device 120, information may be provided using a corresponding communication scheme. For example, when communication between the main electronic device 110 and the sub electronic device can be performed using an NFC scheme, a WiFi scheme, a Bluetooth scheme, a wireless USB scheme, or the like, the main electronic device 110 may generate data for transmitting data with a corresponding wireless communication scheme to provide the data to the sub electronic device 120 in operation 416. In this event, the main electronic device may use at least one piece of information among information obtained in operations 402 and 404 to obtain information on a communication scheme which the sub electronic device may use.

Further, when communication can be performed using a wired USB scheme, an RS232 or RS422 scheme, a specific wired scheme provided in a manufacturer of the electronic device, or the like, the main electronic device 110 may generate data for transmitting data with a corresponding wired communication scheme to provide the data to the sub electronic device 120 in operation 416.

A method of registering personal electronic devices according to various embodiments may include: obtaining an information pattern code related to a second electronic device by a first electronic device; transmitting a registration request message including at least one among identification information on the first electronic device and information included in the obtained information pattern code to a server by the first electronic device; and when the first electronic device has received a message including grouping information from the server, transmitting information related to the grouping information to the second electronic device and designating the first electronic device and the second electronic device as a group.

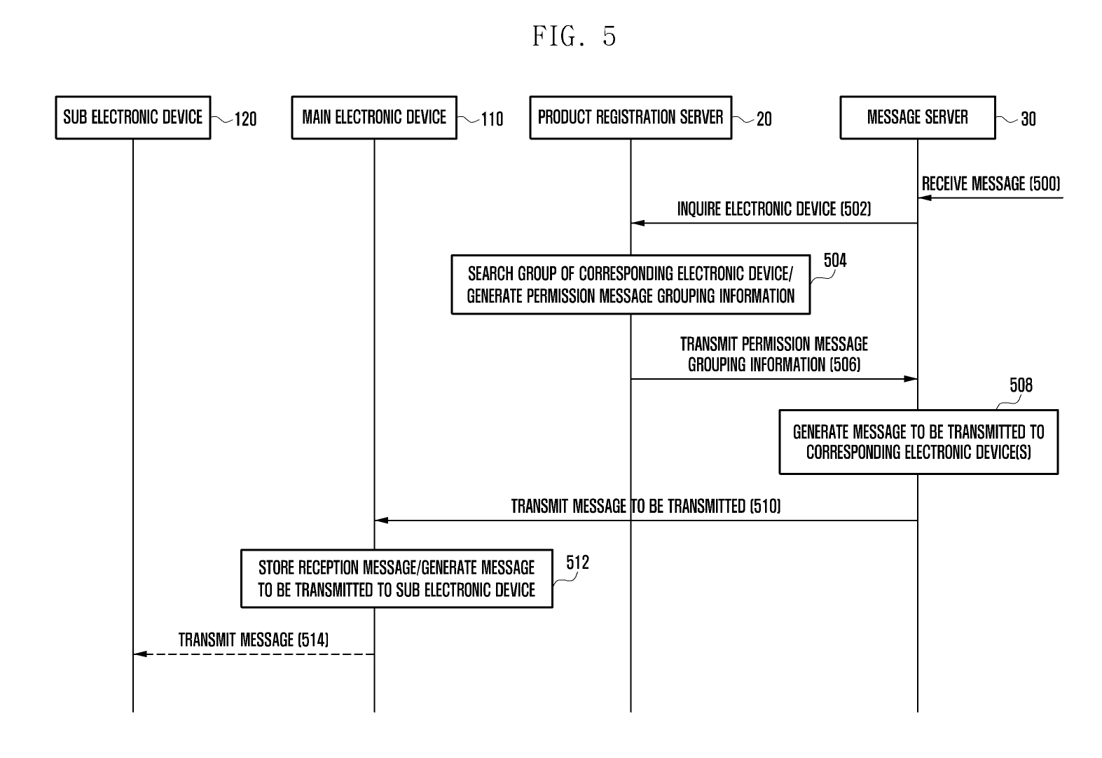

FIG. 5 is a signal flow diagram for providing, when a message to be transmitted to a main electronic device and sub electronic devices is received.

Although any one of the first electronic device 110, second electronic device 120, third electronic device 130, and fourth electronic device 140 can either be the main electronic device or the sub electronic device, in FIG. 5, the main electronic device will be the first electronic device 110 and the sub electronic device will be the second electronic device 120 illustrated in FIG. 1. Further, a configuration of the main electronic device 110 and the sub electronic device 120 will be discussed in reference to configurations of FIGS. 2 and 3.

When a message to be transmitted to a specific electronic device, e.g., the main electronic device 110 has been received in operation 500, the message server 30 may inquire to a product registration server 20 in operation 502 about whether a message should be only transmitted to the main electronic device 110 or whether a message should be transmitted to other electronic devices on an identical level or a lower level. The product registration server 20 may search for electronic devices which are stored in a form of being grouped as the electronic devices of a lower layer of a specific representative electronic device as shown in FIG. 4 in a DB as described above or are grouped into electronic devices having an identical level in operation 504. For example, in the case of a configuration by only the electronic devices having the identical level, the product registration server 20 may generate permission message grouping information to transmit a corresponding message to all electronic devices as described above. On the other hand, when a specific electronic device is configured as a representative electronic device and one or more sub electronic devices are included as the electronic devices of the lower layer of the specific electronic device, information on electronic devices in which a transmission is permitted according to a kind of the message may be generated.

When the permission message has been generated through the method as described above in operation 502, the product registration server 20 may transmit permission message grouping information to the message server 30 in operation 506. In the case of a configuration by only the electronic devices having a common level, electronic devices to which the message is transmitted may be all electronic devices including a corresponding identifier (ID) and according to the various embodiments, in the case of a configuration by a specific main electronic device and the sub electronic device(s), there may be sub electronic device(s) in which the information of the main electronic device and a transmission of the corresponding message are permitted.

When receiving the permission grouping information in operation 506, the message server 30 proceeds to operation 508 and generates a message to be transmitted to a corresponding electronic device(s). In this event, there may be various methods of transmitting a message to an electronic device(s) and two methods will be described as embodiments.

A first method is a method by which the message server 30 transmits a corresponding message to the main electronic device 110 by including information on sub electronic device(s), in which reception of the corresponding message is permitted, among sub electronic device(s) of the lower layer of the main electronic device 110 and a transmission request, so as to transmit a reception message from the main electronic device to a corresponding sub electronic device(s). A second method is a method by which the message server 30 directly transmits the corresponding message to the main electronic device 110 and the corresponding sub electronic device(s).

Operations under operation 510 in FIG. 5 illustrate the first method as an example. The message server 30 may transmit the message to be transmitted to the main electronic device 110 in operation 510. In this event, when a corresponding message should be transmitted to the sub electronic device(s) of a lower layer, the message may include information to be transmitted of the sub electronic device(s) and include information required for transmission of the message to the included sub electronic device(s).

When the main electronic device 110 has received the message as described above in operation 510, the main electronic device 110 provides a message to be provided to the user through a predetermined alarm scheme in operation 512. Further, the main electronic device 110 may change and generate a type of message in order to transmit the received message to the sub electronic device(s) to which the message transmission is requested in operation 512. In this embodiment, the main electronic device 110 receives the message from the mobile communication network and the sub electronic devices receive the message with the WiFi scheme. Then, the main electronic device 110 should change the type of data in order to transmit the message received through the mobile communication network to the sub electronic devices through the WiFi network in operation 512. When the change is completed and the message to be transmitted has been generated, the main electronic device 110 may transmit the message to the sub electronic device 120 in operation 514.

A case in which the message server 30 transmits a message to the main electronic device 110 and the sub electronic device 120 will be discussed as the second method. As described above, in this embodiment, the main electronic device 110 can communicate through the mobile communication network and the WiFi network and the sub electronic device 120 can communicate through the WiFi network. The message server 30 may transmit a corresponding message to the main electronic device 110 through the mobile communication network or/and WiFi network and may transmit a corresponding message to the sub electronic device 120 through the WiFi network.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

The foregoing exemplary embodiments are merely exemplary and are not to be construed as limiting. The present teaching can be readily applied to other types of devices. Also, the description of the exemplary embodiments is intended to be illustrative, and not to limit the scope of the claims and equivalents thereof, and many alternatives, modifications, and variations will be apparent to those skilled in the art.

What is claimed is:

1. A method of grouping personal electronic devices, the method comprising:
obtaining, by a first electronic device, an information code related to a second electronic device;
transmitting a registration request message including at least one among identification information for the first electronic device and information included in the obtained information code to a server by the first electronic device; and
when the first electronic device has received a message including grouping information from the server, transmitting information related to the grouping information to the second electronic device and designating the first electronic device and the second electronic device as a group.

2. The method of claim 1, wherein the information code is either a quick response code or a bar code.

3. The method of claim 2, wherein the first electronic device obtains the information code through a camera module or a sensor module.

4. The method of claim 1, further comprising:
updating the grouping information to a memory by the first electronic device when the message including the grouping information is received from the server.

5. The method of claim 1, wherein transmitting of the information related to the grouping information to the second electronic device by the first electronic device further comprises:
generating another information code for providing the message including the grouping information from the server; and
displaying the another information code through a display module.

6. The method of claim 5, wherein the information code provides information regarding a third electronic device, wherein the third electronic device is in the group with the first electronic device and the second electronic device.

7. The method of claim 1, wherein providing of the grouping information to the second electronic device by the first electronic device comprises transmitting the grouping information using at least one scheme among communication schemes obtained from an information code related to the second electronic device.

8. The method of claim 1, wherein the information included in the information code related to the second electronic device comprises one or more among a device type, a model name of the second electronic device, a device image, a serial number, and a supportable multimedia format of the second electronic device.

9. The method of claim 1, wherein the identification information for the first electronic device is one among a phone number, an e-mail address, a Twitter identifier (ID), a messenger ID or an ID registered in a product registration server.

10. The method of claim 1, further comprising:
receiving an input; and
wherein transmitting the registration request message including the at least one among the identification information for the first electronic device and the information included in the obtained information code to the server by the first electronic device, further comprises: transmitting the information obtained from the information code to the server, responsive to receiving the input.

11. An electronic device for grouping personal electronic devices, the electronic device corresponding to a first electronic device for registering a second electronic device to a server, the electronic device comprising:
a sensor module that recognizes an information code related to the second electronic device;
a memory that stores the from the information code related to the second electronic device, grouping information and identifier information for the first electronic device;
a controller that controls to allow at least one among information included in an information code related to the second electronic device obtained in the sensor module and the identifier information on the first electronic device to be provided to the server, and when a message including the grouping information has been received from the server, controls to provide information related to the grouping information to the second electronic device; and
a communication module that transmits the at least one among the information included in an information code related to the second electronic device obtained in the sensor module and the identifier information for the first electronic device is transmitted to the server, and that receives the message including the grouping information from the server.

12. The electronic device of claim 11, wherein the information code is either a quick response code or a bar code.

13. The electronic device of claim 11, wherein the controller controls to update the grouping information in the memory when the message including the grouping information has been received from the server.

14. The electronic device of claim 11, wherein the controller controls to generate another information code including the grouping information from the server when grouping information is provided to the second electronic device, the electronic device further comprising:
a display module that displays the another information code.

15. The electronic device of claim 11, wherein the controller controls the communication module to transmit the grouping information to the second electronic device using one scheme among communication schemes obtained from the information code related to the second electronic device when the grouping information is provided to the second electronic device.

16. The electronic device of claim 11, wherein the information included in the information code related to the second electronic device comprises one or more among a device type and a model name of a sub electronic device and a device image, a serial number, a supportable multimedia format of the electronic device.

17. The electronic device of claim 11, wherein the identification information on the first electronic device is one among a phone number, an e-mail address, a Twitter identifier (ID), a messenger ID or an ID registered in a product registration server.

18. A non-transitory machine-readable medium storing a plurality of commands, wherein the plurality of commands, when being executed by at least one processor in a first electronic device, cause the at least one processor in the first electronic device to:
receive information included in an information code related to a second electronic device from a sensor module;
provide a registration request message for transmitting at least one among identification information for the first electronic device and information included in the obtained information code to a server by the first electronic device by a communication module; and
provide information related to the grouping information for transmitting to the second electronic device by the communication module and designating the first electronic device and the second electronic device as a group, when the first electronic device has received a message including grouping information from the server.

19. The non-transitory machine-readable medium of claim 18, wherein the plurality of commands, when being executed by the at least one processor in the first electronic device, also cause the at least one processor to:
generate another information code for providing the message including the grouping information from the server; and
provide the another information code for display.

20. The non-transitory machine-readable medium of claim 19. wherein the information code provides information regarding a third electronic device, wherein the third electronic device is in the group with the first electronic device and the second electronic device.
